(19) United States
(12) Patent Application Publication
(10) Pub. No.: US 2024/0147922 A1
(43) Pub. Date: May 9, 2024

(54) IRRIGATION SYSTEM INCLUDING ONE OR MORE TROLLEYS WITH A FUNCTIONAL HEAD

(71) Applicant: CNH Industrial America LLC, New Holland, PA (US)

(72) Inventor: Devin Cooley, Reading, PA (US)

(73) Assignee: CNH Industrial America LLC, New Holland, PA (US)

(21) Appl. No.: 17/980,878

(22) Filed: Nov. 4, 2022

(51) Int. Cl. A01G 25/09; A01B 51/02; A01G 25/02

(52) U.S. Cl. CPC A01G 25/092; A01B 51/02; A01G 25/023; A01G 25/097

(57) ABSTRACT

An irrigation system includes: a pair of legs; an irrigation frame extending between the pair of legs and including at least one fluid conduit; a plurality of fluid dispensers configured to dispense fluid to a field, each of the fluid dispensers being fluidly coupled to the at least one fluid conduit; a trolley track coupled to the irrigation frame; and at least one trolley movably coupled to the trolley track and including a functional head configured to process plants on the field.

### FIELD OF THE INVENTION

The present invention pertains to irrigation systems and, more specifically, to center pivot irrigation systems.

### BACKGROUND OF THE INVENTION

Irrigation of crops is often necessary to ensure that the growing crops have adequate water to mature for harvest. One known type of irrigation system is known as a center pivot irrigation system. A typical center pivot irrigation system has an irrigation frame with a fluid conduit that is coupled to a plurality of fluid dispensers, which distribute fluid from the fluid conduit to the field. The center pivot irrigation system, as its name suggests, pivots about a center point across a field to dispense water to crops in the field.

While such irrigation systems are effective, there remains a need for further improvement of such systems to increase efficiency and/or reduce the involvement of a farmer in managing the field.

### SUMMARY OF THE INVENTION

Exemplary embodiments disclosed herein provide an irrigation system with a trolley track coupled to an irrigation frame and at least one trolley that is configured to move along the trolley track and includes a functional head configured to process plants in a field.

In some exemplary embodiments provided according to the present disclosure, an irrigation system includes: a pair of legs; an irrigation frame extending between the pair of legs, the irrigation frame including at least one fluid conduit; a plurality of fluid dispensers configured to dispense fluid to a field, each of the fluid dispensers being fluidly coupled to the at least one fluid conduit; a trolley track coupled to the irrigation frame; and at least one trolley movably coupled to the trolley track and including a functional head configured to process plants on the field.

In some exemplary embodiments provided according to the present disclosure, a method of processing plants on a field includes: pivoting an irrigation system about a center pivot, the irrigation system including a pair of legs, an irrigation frame extending between the pair of legs, the irrigation frame including at least one fluid conduit, and a plurality of fluid dispensers configured to dispense fluid to the field, each of the fluid dispensers being fluidly coupled to the at least one fluid conduit; moving at least one trolley along a trolley track coupled to the irrigation frame; and processing plants on the field with a functional head carried by the at least one trolley.

One advantage that may be realized by exemplary embodiments provided according to the present disclosure is that the irrigation system can be used to both water and process plants on the field, reducing the need for other equipment.

Another advantage that may be realized by exemplary embodiments provided according to the present disclosure is that the trolley(s) can be modular so the trolley(s) can be replaced with trolley(s) having a different functional head, allowing the irrigation system to perform a variety of crop processing functions.

Another advantage that may be realized by exemplary embodiments provided according to the present disclosure is that the functional head of the trolley(s) can be made modular so the functional head can be replaced with a functional head having a different configuration without needing to replace the entirety of the trolley(s).

Another advantage that may be realized by exemplary embodiments provided according to the present disclosure is that the trolley(s) and functional head can reduce the time and effort needed by an operator to manage the field.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a top view of an exemplary embodiment of an irrigation system provided according to the present disclosure;

FIG. 2 illustrates a side view of the irrigation system of FIG. 1;

FIG. 3 illustrates an exemplary embodiment of a method of processing plants in a field provided according to the present disclosure; and

FIG. 4 illustrates another exemplary embodiment of a method of processing plants in a field provided according to the present disclosure.

### DETAILED DESCRIPTION OF THE INVENTION

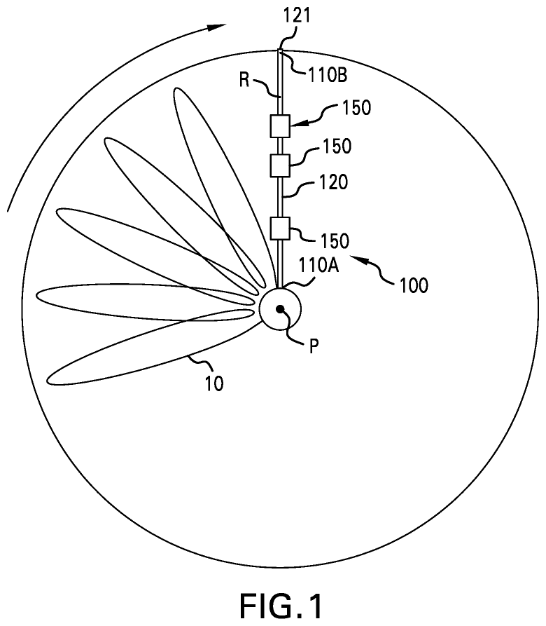

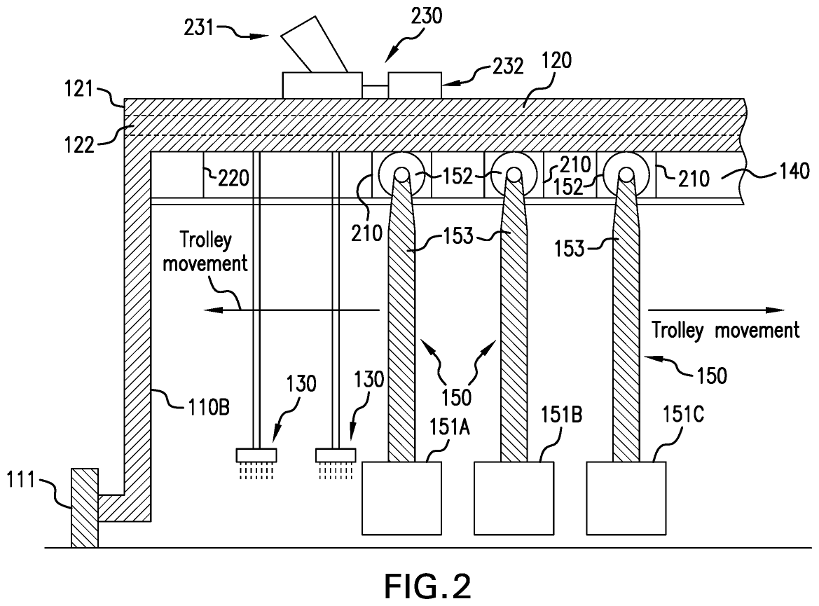

Referring now to the drawings, and more particularly to FIGS. 1-2, an exemplary embodiment of an irrigation system 100 provided according to the present disclosure is illustrated. The irrigation system 100 includes a pair of legs 110A, 110B, an irrigation frame 120 extending between the legs 110A, 110B, a plurality of fluid dispensers 130 that are each configured to dispense fluid to a field, a trolley track 140 coupled to the irrigation frame 120, and at least one trolley, illustrated as a plurality of trolleys 150, movably coupled to the trolley track 140. One or both of the legs 110A, 110B may be coupled to and/or include a traction member, such as a wheel 111. In the illustrated embodiment, one of the legs 110A may be located adjacent to a pivot point P of the irrigation frame 120 and the other leg 110B may be located adjacent to an endpoint 121 of the irrigation frame 120 that defines a pivot radius R of the irrigation system 100. It should be appreciated that while multiple trolleys 150 are illustrated in FIGS. 1-2, in some embodiments only a single trolley 150 is coupled to the trolley track 140.

As can be appreciated from FIG. 1, the irrigation system 100 can be configured to pivot about the pivot point P so the irrigation frame 120 carries the fluid dispensers 130 across the field. The irrigation system 100 may be referred to as a “center pivot” irrigation system due to the irrigation system 100 pivoting about the center pivot point P. The irrigation frame 120 includes at least one fluid conduit, illustrated as a single fluid conduit 122, and each of the fluid dispensers 130 is fluidly coupled to the fluid conduit(s) 122. The fluid conduit(s) 122 may be coupled to a source of irrigation water, such as a pump or pressurized water tank, so irrigation water can be delivered to the field from the fluid dispensers 130 as the fluid dispensers 130 are carried across the field, as is known. The fluid dispensers 130 may be any type of dispenser that is suitable to deliver fluid to the field, including but not limited to nozzles, spigots, etc. Such fluid dispensers are well-known in the art so further description is omitted for brevity.

Known center pivot irrigation systems are effective for providing irrigation water to a field. However, irrigation is not the only function needed to manage the field. The farmer generally uses one or more separate vehicles, such as a mower and a windrower, to perform these activities, which is inconvenient for the farmer and requires the farmer to actively perform the activities.

To address some of the issues with known irrigation systems, the irrigation system 100 provided according to the present disclosure includes the trolley track 140 and one or more trolleys 150 movably coupled to the trolley track 140. The one or more trolleys 150 include a functional head 151A, 151B, 151C that is configured to process plants on the field. As used herein, the functional heads 151A, 151B, 151C are configured to “process” plants in the sense that the functional heads 151A, 151B, 151C are structured to interact with plants, either standing or cut, in the field in order to alter and/or move the plants. The plants may be crops, such as wheat or corn, and/or may be non-crop plants, such as weeds. The trolleys 150 may move along the trolley track 140 as the irrigation frame 120 pivots about the pivot point P. Due to the irrigation frame 120 pivoting about the pivot point P relatively slowly, the trolleys 150 can move along the trolley track 140 between the legs 110A, 110B so each of the trolleys 150 continuously travels along the entire radius R as the irrigation frame 120 pivots. As the trolleys 150 move along the trolley track 140, each of the carried functional heads 151A, 151B, 151C can process plants in a travel path, illustrated as path 10 in FIG. 1. The trolleys 150 can thus be configured to move along the trolley track 140 at a speed that allows the functional heads 151A, 151B, 151C to process all plants in the field as the irrigation frame 120 pivots about the pivot point P, allowing the farmer to use the irrigation system 100 to process the plants in addition to providing irrigation water to the field.

The functional heads 151A, 151B, 151C may be provided to perform a variety of functions. The functional head 151A may be, for example, a cutter that is configured to cut crop material in the field. The functional head 151A may thus include a blade or other cutting element that cuts plants as the irrigation frame 120 pivots about the pivot point P. The functional head 151B may be, for example, a rake including a plurality of tines that grab cut plants as the irrigation frame 120 pivots about the pivot point P. The functional head 151C may be, for example, a crop transporter that is configured to carry the cut plants from the field toward one of the legs 110A, 110B for collection. It should be appreciated that while the functional heads 151A, 151B, 151C are described as being a cutter, a rake, and/or a crop transporter, the functional heads may be provided in other forms to perform other plant processing functions. For example, the functional head may be a crop packager that bundles crops together (in a bale or otherwise) or a weed eliminator that identifies and/or eliminates weeds by mechanical disruption and/or applying herbicide and/or electrical current to weeds. The functional head may also be a planting apparatus, such as a seed depositor. Many such cutters, rakes, crop packagers, crop transporters, weed eliminators, and planting apparatuses are known in the art.

In some embodiments, one or more of the trolleys 150, such as all of the trolleys, may be reversibly coupled to the trolley track 140. As used herein, a trolley 150 is “reversibly coupled” to the trolley track 140 when the trolley 150 can be uncoupled from the trolley track 140 in a manner that does not detrimentally affect the structure of the trolley track 140 and/or the trolley 150. Each of the trolleys 150 may be, for example, slidably coupled to the trolley track 140 by including a roller 152 that is configured to slide along the trolley track 140. The functional heads 151A, 151B, 151C may be coupled to the roller 152 by a trolley arm 153 so sliding of the roller 152 along the trolley track 140 carries the respectively coupled functional head 151A, 151B, 151C in a direction of the trolley track 140. It should be appreciated that while one roller 152 is illustrated and described as being coupled to the trolleys 150, in some embodiments one or more of the trolleys 150 may be coupled to multiple rollers, such as a pair of rollers. By reversibly coupling the trolleys 150 to the trolley track 140, different trolleys can be run on the trolley track 140 at different times. For example, all of the trolleys 150 on the trolley track 140 at a given time may carry the same type of functional head, such as cutters 151A, so the trolleys 150 all carry cutters 151A across the field to cut crop material as the irrigation frame 120 pivots. Once the irrigation frame 120 has pivoted across the entire field so the cutters 151A have cut all the crop material, the trolleys 150 can be replaced with different trolleys that carry a different functional head, such as a rake, so the trolleys 150 can rake the cut crop material during the next pivoting cycle of the irrigation frame 120 about the pivot point P.

In some embodiments, the functional heads 151A, 151B, 151C are reversibly coupled to the trolleys 150 so the trolleys 150 can be provided with different functions by removing and replacing the coupled functional head 151A, 151B, 151C. The functional heads 151A, 151B, 151C may, for example, be mechanically coupled to its respective trolley 150, e.g., by a drive shaft, in a manner that both reversibly couples the functional head 151A, 151B, 151C to the trolley 150 and also provides any necessary power to the functional head 151A, 151B, 151C. Once the functional head 151A, 151B, 151C has processed plants across the entire field, the functional head 151A, 151B, 151C may be removed and replaced by a different functional head.

The irrigation system 100 may further include at least one motor 210 that is coupled to at least one of the trolleys 150 and configured to move the respectively coupled trolley(s) 150 across the trolley track 140. In some embodiments, a single motor 210 is coupled to multiple trolleys 150 so the coupled trolleys 150 all move along the trolley track 140 at the same speed. It should be appreciated that, alternatively, each of the trolleys 150 may be coupled to its own respective motor 210 so each of the trolleys 150 may move along the trolley track 140 at its own independent speed relative to the other trolleys 150; when only one trolley 150 is provided, such a trolley will necessarily be coupled to its own motor 210. The motor 210 may, for example, be coupled to the roller 152 of each trolley 150 and configured to rotate the coupled roller 152 so the respectively coupled trolley 150 slides along the trolley track 140 due to rotation of the coupled roller 152.

In some embodiments, the irrigation system 100 further includes a controller 220 that is operably coupled to the at least one motor 210 and is configured to output a movement signal to the motor(s) 210 that causes the motor(s) 210 to move the respectively coupled trolley(s) 150 across the trolley track 140. The controller 220 may be configured, for example, to output movement signals that cause the motor(s) 210 to carry trolleys 150 with different functional heads at different speeds. For example, the controller 220 may be configured to output a rake movement signal to one or more motors 210 coupled to a trolley 150 equipped with a rake 151B so the motor(s) 210 moves all of the trolleys 150 carrying a rake 151B at the same speed. The controller 220 can be similarly configured to output a cutter movement signal and a transport movement signal to one or more motors 210 so trolleys 150 carrying cutters 151A and crop transporters 151C move at the same respective speed. The controller 220 may also be configured to output movement signals that cause the trolleys 150 to move at different speeds along the trolley track 140.

The irrigation system 100 may include elements that require power to operate. For example, the irrigation system 100 may include trolleys 150 equipped with a cutter 151A that uses mechanical or electrical power to rotate a blade and cut plants. If the functional head 151A requires mechanical power to function and does not have its own way to produce mechanical power, the functional head 151A may get the needed mechanical power from the trolley 150, e.g., by a mechanical coupling such as a drive shaft. The trolley 150, in turn, may utilize electrical power to produce the mechanical power used by the functional head 151A. To provide electrical power, the irrigation system 100 may include an electrical system 230 that is electrically coupled to the trolley(s) 150. The electrical system 230 may, for example, be electrically coupled to the trolley(s) 150 by one or more conductive wires. In some embodiments, the electrical system 230 is electrically coupled to the trolley track 140 such that the trolley track 140 is electrified. In such embodiments, the trolley track 140 should be electrically conductive, e.g., by comprising electrically conductive materials such as metals. The electrical system 230 may include an electricity generator 231, such as one or more solar panels, as well as a battery 232 that is configured to store electrical power. Alternatively, the electrical system 230 may be connected to mains power or some other source of electrical power that is remote from the irrigation system 100. By electrifying the trolley track 140, various elements of the irrigation system 100 can be electrically powered without needing to carry their own source of electrical power and without using many separate wires. For example, one or more of the functional heads, such as the cutters 151A, may be electrically coupled to the electrified trolley track 140 to power the functional heads 151A. The functional head(s) 151A, 151B, 151C may be electrically coupled to the electrified trolley track 140 via the roller 152 and/or the trolley arm 153. Electrifying the trolley track 140 thus represents an efficient way to provide electrical power to various elements of the irrigation system 100 including but not limited to one or more of the functional heads 151A, 151B, 151C, the motor 210, and/or the controller 220. Alternatively, or in addition, the functional heads 151A, 151B, 151C can be mechanically coupled to the trolley(s) 150, as previously described, which may itself be electrically powered and produce the mechanical power that drives the functional head via the drive shaft coupling.

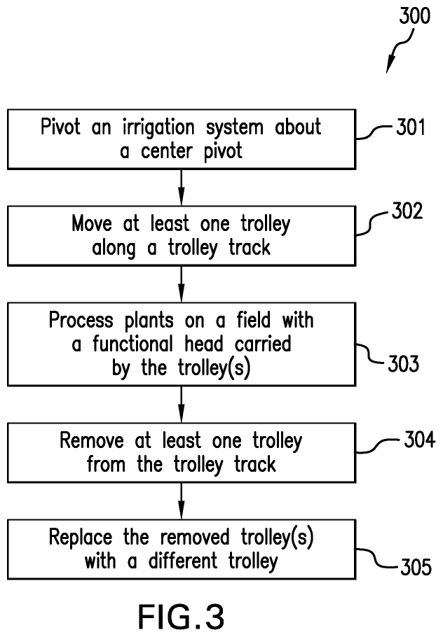

Referring now to FIG. 3, an exemplary embodiment of a method 300 of processing plants on a field is illustrated. The method 300 includes pivoting 301 the irrigation system 100 about a center pivot, such as the pivot point P, moving 302 one or more trolleys 150 along the trolley track 140 coupled to the irrigation frame 120, and processing plants 303 on the field with the functional head 151A, 151B, 151C carried by the trolley(s) 150. Moving 302 the trolleys 150 may include, for example, sliding the trolleys 150 along the trolley track 140. Processing plants 303 may include various processes, depending on the functional head 151A, 151B, 151C carried by the trolleys 150. When the functional head 151A is a cutter, processing plants 303 may include cutting standing plants in the field with the cutter 151A. When the functional head 151B is a rake, processing plants 303 may include raking cut plants in the field with the rake 151B. When the functional head 151C is a crop transporter, processing plants 303 may include transporting cut plants in the field with the crop transporter 151C. When the functional head is a crop packager, processing plants 303 may include packaging cut crops together in a bundle. When the functional head is a weed eliminator, processing plants 303 may include eliminating weeds by mechanical disruption and/or applying herbicide and/or electrical current to weeds. When the functional head is a planting apparatus, processing plants 303 may include planting one or more plants by, for example, depositing one or more seeds in the field. In some embodiments, the method 300 may further include removing 304 at least one of the trolleys 150 from the trolley track 140 and replacing 305 the removed trolley(s) 150 with a different trolley that has a functional head that differs from the functional head of the removed trolley(s) 150. For example, a trolley 150 that includes a functional head in the form of a cutter 151A may be removed 304 from the trolley track 140 and replaced with a trolley 150 that includes a functional head in the form of a rake 151B. In this sense, the trolleys 150 provided according to the present disclosure are modular and may be removed and replaced, as desired, so the irrigation system 100 performs different processing functions of plants.

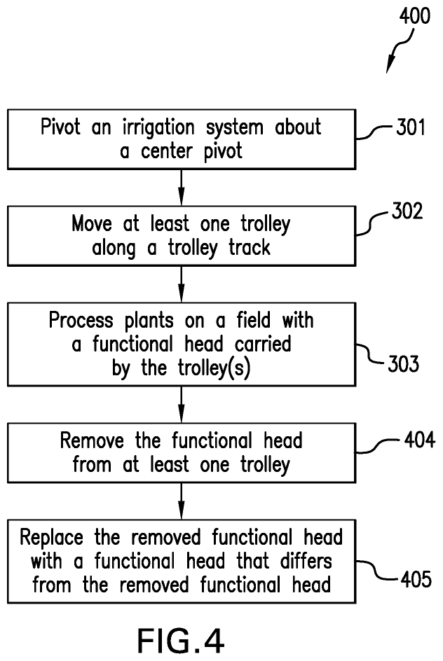

Referring now to FIG. 4, another exemplary embodiment of a method 400 of processing plants on a field is illustrated. The method 400 is similar to the previously described method 300 in that the method 400 includes pivoting 301 the irrigation system 100 about a center pivot, such as the pivot point P, moving 302 the trolley(s) 150 along the trolley track 140 coupled to the irrigation frame 120, and processing plants 303 on the field with the functional head 151A, 151B, 151C carried by the trolley(s) 150. Unlike the previously described method 300, which included removing 304 and replacing 305 at least one trolley, the method 400 may further include removing 404 a functional head 151A, 151B, 151C from one or more trolleys 150 and replacing 405 the removed functional head with a functional head that differs from the removed functional head. For example, a cutter 151A may be removed from its respective trolley 150 and replaced with a rake 151B. It should thus be appreciated that the functional heads provided according to the present disclosure may be removable and replaceable to conveniently alter the function of each trolley 150.

From the foregoing, it should be appreciated that the irrigation system 100 provided according to the present disclosure allows a farmer to not only provide irrigation water to a field but also process plants that are on the field using one or more trolleys 150. Such an irrigation system 100 reduces the need for the farmer to use other constructions, such as a mower and/or a windrower, to process plants after watering. The trolleys 150 can carry a wide variety of functional heads to perform a wide variety of plant processing functions. Therefore, the irrigation system 100 provided according to the present disclosure allows a farmer to water and process plants in a field using a single system.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An irrigation system, comprising:
a pair of legs;
an irrigation frame extending between the pair of legs, the irrigation frame comprising at least one fluid conduit;
a plurality of fluid dispensers configured to dispense fluid to a field, each of the fluid dispensers being fluidly coupled to the at least one fluid conduit;
a trolley track coupled to the irrigation frame; and
at least one trolley movably coupled to the trolley track and comprising a functional head configured to process plants on the field.

2. The irrigation system of claim 1, wherein the at least one trolley is reversibly coupled to the trolley track.

3. The irrigation system of claim 1, wherein the at least one trolley is slidably coupled to the trolley track.

4. The irrigation system of claim 3, wherein the at least one trolley comprises a roller that is configured to slide along the trolley track.

5. The irrigation system of claim 1, further comprising at least one motor coupled to the at least one trolley and configured to move the respectively coupled at least one trolley across the trolley track.

6. The irrigation system of claim 5, further comprising a controller operably coupled to the at least one motor, the controller being configured to output a movement signal to the at least one motor that causes the at least one motor to move the respectively coupled at least one trolley across the trolley track.

7. The irrigation system of claim 1, further comprising an electrical system that is electrically coupled to the trolley track such that the trolley track is electrified.

8. The irrigation system of claim 1, wherein the functional head is reversibly coupled to the at least one trolley.

9. The irrigation system of claim 1, wherein the functional head comprises a cutter, a rake, a crop transporter, or a planting apparatus.

10. The irrigation system of claim 9, wherein the functional head comprises a cutter.

11. The irrigation system of claim 9, wherein the functional head comprises a rake.

12. The irrigation system of claim 9, wherein the functional head comprises a crop transporter.

13. A method of processing plants on a field, the method comprising:
pivoting an irrigation system about a center pivot, the irrigation system comprising a pair of legs, an irrigation frame extending between the pair of legs, the irrigation frame comprising at least one fluid conduit, and a plurality of fluid dispensers configured to dispense fluid to the field, each of the fluid dispensers being fluidly coupled to the at least one fluid conduit;
moving at least one trolley along a trolley track coupled to the irrigation frame; and
processing plants on the field with a functional head carried by the at least one trolley.

14. The method of claim 13, wherein moving the at least one trolley comprises sliding the at least one trolley along the trolley track.

15. The method of claim 13, wherein the functional head comprises a cutter, a rake, or a crop transporter.

16. The method of claim 15, wherein the functional head comprises a cutter and the processing comprises cutting standing plants in the field with the cutter.

17. The method of claim 15, wherein the functional head comprises a rake and the processing comprises raking cut plants in the field with the rake.

18. The method of claim 15, wherein the functional head comprises a crop transporter and the processing comprises transporting cut plants in the field with the crop transporter.

19. The method of claim 13, further comprising:
removing the at least one trolley from the trolley track; and
replacing the at least one removed trolley with a different trolley comprising a functional head that differs from the functional head of the at least one removed trolley.

20. The method of claim 13, further comprising:
removing the functional head from the at least one trolley; and
replacing the removed functional head with a different functional head that differs from the removed functional head.
